(19) United States
(12) Patent Application Publication
(10) Pub. No.: US 2015/0220599 A1
(43) Pub. Date: Aug. 6, 2015

(54) AUTOMOBILE AIRBAG DEPLOYMENT DEPENDENT ON PASSENGER SIZE

(71) Applicant: INTERNATIONAL BUSINESS MACHINES CORPORATION, ARMONK, NY (US)

(72) Inventor: Eric Vance Kline, Rochester, MN (US)

(73) Assignee: INTERNATIONAL BUSINESS MACHINES CORPORATION, ARMONK, NY (US)

(21) Appl. No.: 14/169,427

(22) Filed: Jan. 31, 2014

(51) Int. Cl. G06F 17/30; H04L 29/08

(52) U.S. Cl. CPC G06F 17/30477; H04L 67/22; G06F 17/30309

(57) ABSTRACT

Tracking all accessing of individual files in a database that do not change a files content, and generating and storing for an accessed file, metadata defining the accessing. Thus, the stored metadata for metadata describing the accessing of the files in said database covers all accessing of files irrespective of whether files have been modified.

### TECHNICAL FIELD

The present invention relates to computer controlled implementations for searching for and retrieving files in a database.

### BACKGROUND OF RELATED ART

The Internet, and like networks, have provided an environment for virtually instant access to all matter of knowledge and data. A user may assemble, in minutes, vast collections of knowledge and ancillary data that, in previous generations, would have taken days and even months of real time hands-on trudges. However, these instantaneous assemblies of knowledge are in the form of computer data. While the human brain may have vast reasoning powers, it has very limited capability for the instant storage or collection of knowledge in memory. Thus, when navigating through such collections of data, the user is likely to remember substantive or content data in the area of interest but is also likely to remember only combinations of fragments about the organization of the data in the various databases from which the collected data was taken and even the organization of data in the database that the user has organized for the information resulting from such Internet searches.

The computer art has organized data so as to be accessible through the user of metadata that may be defined as data about data. Metadata may be further divided into two categories: structural metadata describing the organization and modification of the files in a database; and descriptive metadata that may be defined as data about data content in the files organized as defined by the structural metadata.

In our present complex and overburdened workplaces, wherein users often need to multiplex between multiple projects and their ancillary data collections almost on a 24 hour basis, the user on returning to project is faced with “ . . . now where was I?”. Also, when a user is developing information, he may recall a potentially important piece of information but the user has a problem in specifying “ . . . when and where.

### SUMMARY OF THE PRESENT INVENTION

The present invention provides an implementation for retrieving information from files in databases of files. The present invention has recognized that the computer arts maintain metadata about when files in a database were modified and the extent of such modifications, there appears to be no metadata regarding the past accessing of files from a database wherein there was no modification of the files.

Accordingly, the invention provides an implementation for retrieving data from files in a database of files that comprises tracking all accessing of individual files in a database that changes file content, and generating and storing for an accessed file, metadata defining said accessing and change. However, the present invention further tracks all accessing of individual files in a database that does not change file content and generates and stores for an accessed file, metadata defining the accessing. Thus, the stored metadata for metadata describing the accessing of the files in said database covers all accessing of files irrespective of whether files have been modified.

In accordance with one aspect of the invention, searching may be for only metadata describing accessing of files that does not change the content of files.

One significant aspect of such accessing that does not change the file contents includes reading of a file. Another significant aspect of accessing without file change includes copying of content from a file.

Where the access does not change file content, the metadata may include the length of time that the file is accessed.

Further, wherein the file is only copied from, the tracked and stored metadata for the file may include the size and content of the copied portion, as well as where the copied portion was pasted.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized diagrammatic view of a portion of a computer controlled display screen illustrating a user interface through which the present invention may be implemented;

FIG. 2 is a block diagram of a generalized display computer system including a processor unit that may perform the functions of the display terminal computers of FIG. 1;

FIG. 3 is an illustrative flowchart describing the setting up of the process of the present invention for tracking and storage of metadata on files that have been accessed without modification; and

FIG. 4 is a flowchart of an illustrative run of the process setup in FIG. 3.

### DETAILED DESCRIPTION OF THE PREFERRED EMBODIMENT

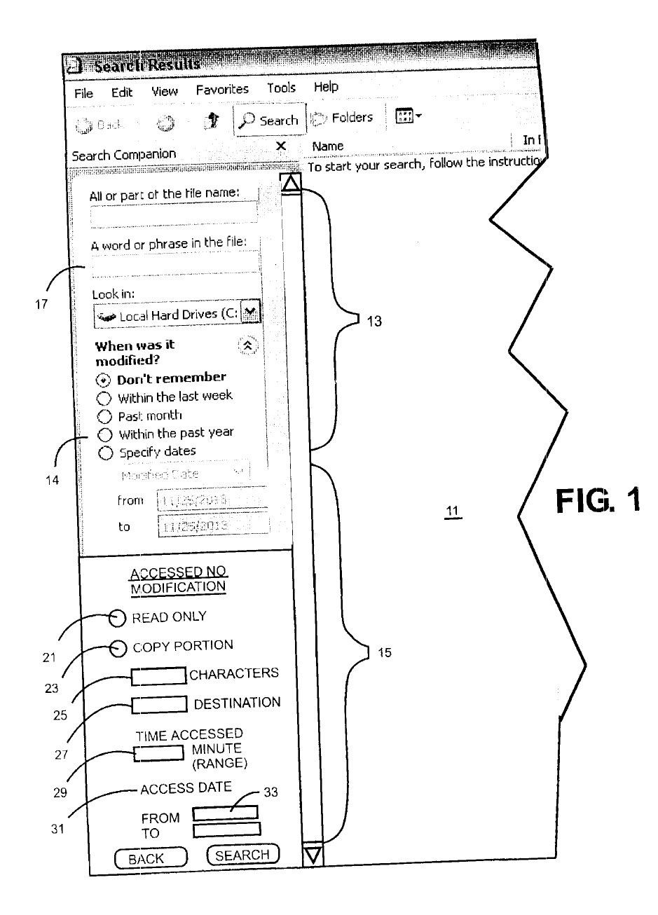

Referring to FIG. 1, there is illustrated a generalized view of a portion of a computer controlled display screen 11 illustrating a user interface in this invention. Assume that we are dealing with users who believe that they have previously accessed files from one or a plurality of databases and now wish to access such files to retrieve data. There is a dialog sequence 13 of conventional criteria 19 that may be entered, such as file names or portions of such names, words or phrases from the file that the user may recollect and the databases or data content sources, e.g. C Drive (C:). Then, there is input on when the file was modified, a sequence of interactive dialog entries attempting to hone in on the time period of the modification of files. It is to be noted that all of conventional entries 13 require input relative to when the particular files were modified. Conventional metadata supporting the access of files in a database only track the access of files that have been modified.

The present invention has recognized that a user trying to put together fragments of recollection may recall accessing files wherein the accessed files were not modified, e.g. reading a file or copying from a file. Thus, the present invention provides for the tracking of and accessing of files that have not been modified, and for the storing of metadata for such files. Thus, there is provided a set for search input for files accessed without modification 15 including read only files 21, files accessed and a portion of the files copied 23. With such copied files, the tracked metadata may include size of portion 25 and destination copied to 24. The tracked metadata for files accessed without modification may include, for files only, the amount of time for such reading 29 and the range of dates within which the file may have been accessed 31.

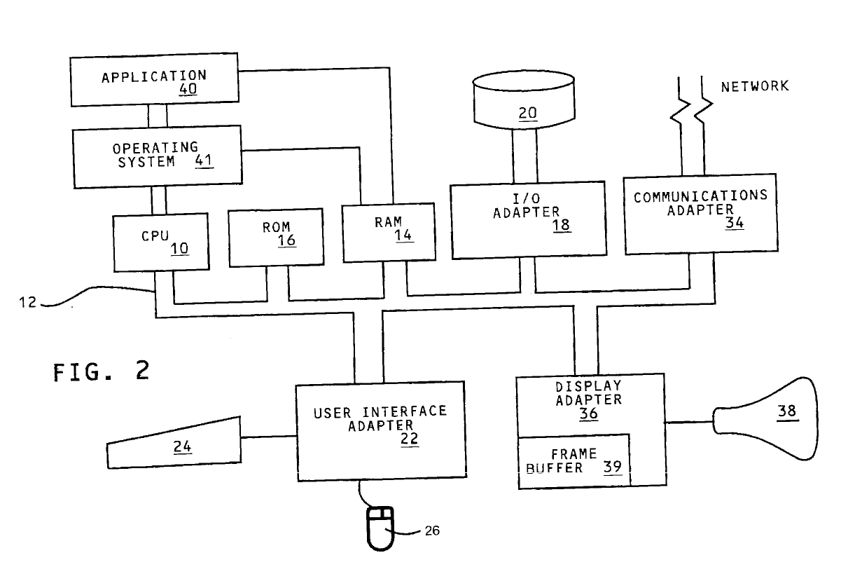

Referring to FIG. 2, a typical data processing system is shown that may function as the computer system including a processor unit that may perform the functions of the display terminal computers of FIG. 1. A central processing unit (CPU) 10 may be one of the commercial microprocessors in personal computers available from International Business Machines Corporation (IBM) or Dell Corporation. The CPU is interconnected to various other components by system bus 12. An operating system 41 runs on CPU 10, provides control and is used to coordinate the function of the various components of FIG. 2. Operating system 41 may be one of the commercially available operating systems. Application programs 40, controlled by the system, are moved into and out of the main memory Random Access Memory (RAM) 14. These programs include the application programs of the present invention for tracking of unmodified accessed files and the storage of metadata defining such access. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 communicates with the disk storage device 20. Communications adapter 34 interconnects bus 12 with the Internet enabling the computer system to communicate with the Internet I/O devices, keyboard 24 and mouse 26 are also connected to system bus 12 via user interface adapter 22. Display adapter 36 includes a frame buffer 39 that is a storage device that holds a representation of each pixel on the display screen 38. Images may be stored in frame buffer 39 for display on monitor 38.

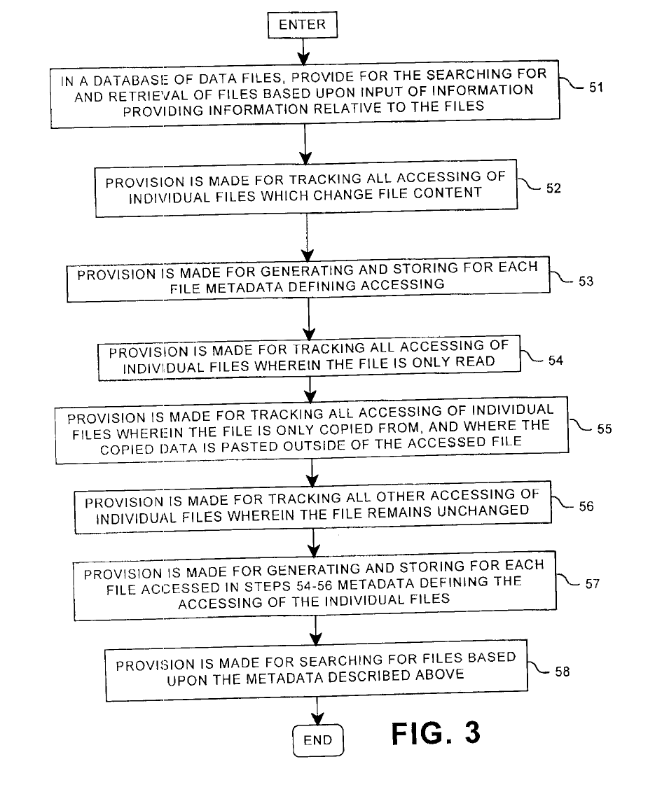

Now with reference to FIG. 3, we will describe the setting up of a method and computer program according to the present invention for tracking and storage of metadata on files that have been accessed without modification. In a database of data files, provision is made for the searching and retrieval of files based upon the input of information that provides information relative to the files, step 51. Provision is made for the tracking of all accessing of files that change content of the accessed files, step 52. Provision is made for the generating and storing of metadata for each accessed file defining the accessing and changes in content, step 53. Provision is made for the tracking of all accessing of files wherein the file is only read, step 54. Provision is made for the tracking of all accessing of files wherein the file is only copied from and where the copied file may be pasted in a file outside of the copied file, step 55. Provision is made for the tracking of all accessing of files wherein the file is unchanged, step 56. Provision is made for generating and storing, for each file accessed in steps 54 through 56, metadata defining the accessing of the individual files, step 57. Provision is made for searching for files based upon the metadata described hereinabove, step 57.

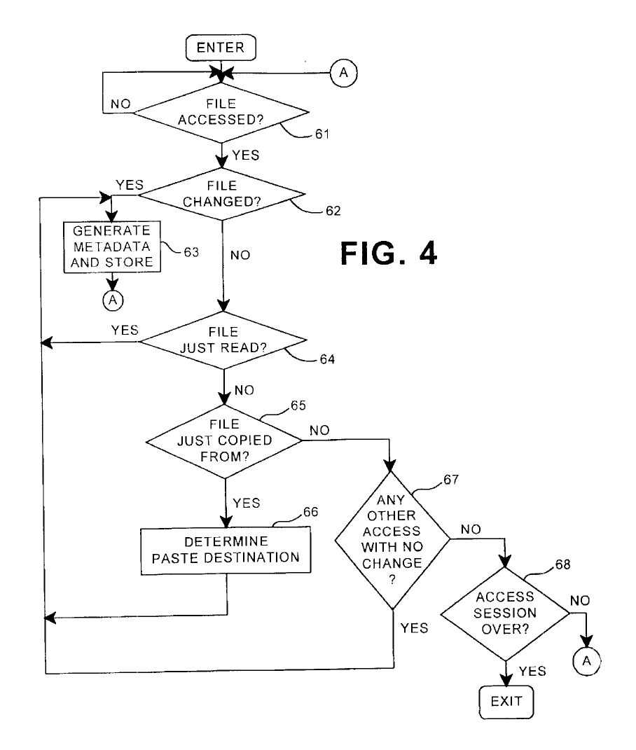

Now that the basic program set up has been described, there will be described with respect to FIG. 4 a flowchart of an operation showing how the program may be run. An initial determination is made as to whether a file has been accessed, step 61. If Yes, then a further determination is made as to whether the accessed file has been changed, step 62. If Yes, metadata defining the changed file is generated and stored, step 63. If No, a determination is made as to whether the file was just read, step 64. If Yes, then the process is returned to step 63 wherein metadata defining the read file is generated and stored, step 63. If No in step 64, a further determination is made as to whether the file was copied from, step 65. If Yes, then a determination is made as to where the copied portion of the file was pasted, step 66, and the process is returned to step 63 wherein metadata defining the copied file is generated and stored. If the determination in step 65 is No, then, step 67, a determination is made as to whether there is any other access to files without change. If Yes, the process is returned to step 63 wherein metadata defining the accessed file is generated and stored. If the determination in step 67 is No, then a determination is made, step 68, as to whether the session is over. If Yes, the session is exited. If No, or after step 63, the session is returned to step 61 via branch “A”.

As will be appreciated by one skilled in the art, aspects of the present invention may be embodied as a system, method or computer program product. Accordingly, aspects of the present invention may take the form of an entirely hardware embodiment, an entirely software embodiment, including firmware, resident software, micro-code, etc.; or an embodiment combining software and hardware aspects that may all generally be referred to herein as a “circuit”, “module” or “system.” Furthermore, aspects of the present invention may take the form of a computer program product embodied in one or more computer readable mediums having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared or semiconductor system, apparatus or device, or any suitable combination of the foregoing. More specific examples (a non-exhaustive list) of the computer readable storage medium would include the following: an electrical connection having one or more wires, a portable computer diskette, a hard disk, a Random Access Memory (“RAM”), a Read Only Memory (“ROM”), an Erasable Programmable Read Only Memory (“EPROM” or Flash memory), an optical fiber, a portable compact disc read only memory (“CD-ROM”), an optical storage device, a magnetic storage device or any suitable combination of the foregoing. In the context of this document, a computer readable storage medium may be any tangible medium that can contain or store a program for use by or in connection with an instruction execution system, apparatus or device.

A computer readable medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate or transport a program for use by or in connection with an instruction execution system, apparatus or device.

Program code embodied on a computer readable medium may be transmitted using any appropriate medium, including, but not limited to, wireless, wire line, optical fiber cable, RF, etc., or any suitable combination the foregoing.

Computer program code for carrying out operations for aspects of the present invention may be written in any combination of one or more programming languages, including an object oriented programming language, such as Java. Smalltalk, C++ and the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the later scenario, the remote computer may be connected to the user's computer through any type of network, including a local area network (“LAN”) or a wide area network (“WAN”), or the connection may be made to an external computer (for example, through the Internet, using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer or other programmable data processing apparatus to produce a machine, such that instructions, which execute via the processor of the computer or other programmable data processing apparatus, create means for implementing the functions/acts specified flowchart and/or block diagram block or blocks.

These computer program instructions may also be stored in a computer readable medium that can direct a computer, other programmable data processing apparatus or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagram in the Figures illustrate the architecture, functionality and operations of possible implementations of systems, methods and computer program products according to various embodiments of the present invention. In this regard, each block in the flowchart or block diagrams may represent a module segment, or portion of code, which comprises one or more executable instructions for implementing the specified logical function(s). It should be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustrations can be implemented by special purpose hardware-based systems that perform the specified functions or acts, or combinations of special purpose hardware and computer instructions.

Although certain preferred embodiments have been shown and described, it will be understood that many changes and modifications may be made therein without departing from the scope and intent of the appended claims

1-7. (canceled)

8. A computer controlled display system for retrieving data from files in a database of files, said system comprising:
a processor;
a computer memory holding computer program instructions which when executed by the processor perform the method comprising:
tracking all accessing of individual files in database which change file content;
generating and storing for an accessed file, metadata defining said accessing and change;
tracking all accessing of individual files in database which do not change a file content;
generating and storing for an accessed file, metadata defining said accessing; and
searching said stored metadata for metadata describing the accessing of said files in said database.

9. The system of claim 8, wherein said searching in the performed method is for only metadata describing accessing of files which does not change the content of files.

10. The system of claim 9, wherein such accessing in the performed method which does not change the file contents includes reading of a file.

11. The system of claim 9, wherein such accessing in the performed method which does not change the file contents includes copying of content from a file.

12. The system of claim 8, wherein said stored metadata for an accessed files in database which does not change a file content includes the length of time that the file is accessed.

13. The system of claim 8, wherein:
said accessing, in the performed method, of individual files in database which does not change a file content is copying a portion of file content; and
said stored metadata for said file includes the size and content of the copied portion.

14. The system of claim 13, wherein said stored metadata further includes where the copied portion was pasted.

15. A computer usable storage medium having stored thereon a computer readable program for retrieving data from files in a database of files, wherein the computer readable program when executed on a computer causes the computer to:
track all accessing of individual files in database which change file content;
generate and store for an accessed file, metadata defining said accessing and change;
track all accessing of individual files in database which do not change a file content;
generate and store for an accessed file, metadata defining said accessing; and
search said stored metadata for metadata describing the accessing of said files in said database.

16. The computer usable storage medium of claim 15, wherein said computer program when executed causes said computer to search for only metadata describing accessing of files which do not change the content of files.

17. The computer usable storage medium of claim 16, wherein such accessing which does not change the file contents includes reading of a file.

18. The computer usable storage medium of claim 16, wherein such accessing which does not change the file contents includes copying of content from a file.

19. The computer usable storage medium of claim 15, wherein said stored metadata for an accessed files in database which does not change a file content includes the length of time that the file is accessed.

20. The computer usable storage medium of claim 15, wherein:
said accessing of individual files in database which does not change a file content is copying a portion of file content; and
said stored metadata for said file includes the size and content of the copied portion.

21. The computer usable storage medium of claim 20, wherein said stored metadata further includes where the copied portion was pasted.
